(19) United States
(12) Patent Application Publication
(10) Pub. No.: US 2011/0085604 A1
(43) Pub. Date: Apr. 14, 2011

(54) IMAGE PROCESSING DEVICE, SYSTEM AND METHOD

(75) Inventor: Hajime Matsui, Kawasaki-shi (JP)

(73) Assignee: KABUSHIKI KAISHA TOSHIBA, Tokyo (JP)

(21) Appl. No.: 12/844,039

(22) Filed: Jul. 27, 2010

(30) Foreign Application Priority Data
Oct. 13, 2009 (JP) 2009-236439

(51) Int. Cl. H04N 7/26

(52) U.S. Cl. 375/240.26; 375/E07.026

(57) ABSTRACT

According to one embodiment, an image processing device includes an image decoder, an encoding difficulty calculator, an encoding difficulty modifier, a coding volume controller, an image encoder. The image decoder is configured to decode a compression coded input video signal and configured to calculate an image characteristic value of the decoded signal. The encoding difficulty calculator is configured to calculate a first encoding difficulty indicative of a compression-coding difficulty of the decoded signal based on the image characteristic value. The encoding difficulty modifier is configured to generate a second encoding difficulty based on the first encoding difficulty and an image characteristic information set from outside for re-compression-coding the input video signal with a predetermined coding volume. The coding volume controller is configured to set a coding volume to be assigned based on the second encoding difficulty. The image encoder is configured to generate an output video signal by re-compression-coding the decoded signal with the assigned coding volume.

### CROSS REFERENCE TO RELATED APPLICATIONS

This application is based upon and claims the benefit of priority from the prior Japanese Patent Application 2009-236439, filed on Oct. 13, 2009, the entire contents of which are incorporated herein by reference.

### FIELD

Embodiments described herein relate generally to an image processing device, system and method.

### BACKGROUND

Recently, an MPEG-2 standard is used in various fields such as a DVD (digital versatile disk) and digital broadcast as a scheme for compression-coding a video signal. Furthermore, an H.264 standard has been developed as a compression-coding scheme which can improve a compression ratio and is used in one-segment broadcast and so on. In recent years, it has been researched and developed to compression-code a video signal at higher compression ratio to record the video signal of longer time, for example, by lowering a bit rate of the video signal of the digital broadcast or converting the video signal of MPEG-2 into a video signal of H.264 scheme when the digital broadcast is recorded in a DVD recorder or a cellular phone. In this case, it is necessary to improve the compression ratio while suppressing degradation of image quality and to perform the compression-coding process in real-time.

A compression-coding technique called two pass encoding is known, which can improve the compression ratio while suppressing the degradation of the image quality. However, there is a problem that compression-coding cannot be performed in real-time by the two pass encoding technique.

JP-A No. 2006-67098 (Kokai) (hereinafter, “Patent Document 1”) discloses a transcoder which decodes a compression-coded input video signal to generate a non-compressed signal and re-compression-codes the non-compressed signal to generate an output video signal, as a technique for compression-coding the signal in real-time. The transcoder sets a code volume to be assigned by each picture in the case of re-compression-coding the decoded signal based on an encoding difficulty calculated when decoding the input video signal. Therefore, when a picture type, an encoding order and relevance of the pictures in the input video signal are the same as those in the output video signal, it is possible to assign a larger amount of the code volume to pictures that compression is difficult, thereby improving the compression ratio while suppressing the degradation of the image quality.

However, the picture type and so on in the input video signal are not always the same as those in the output video signal. When not the same, there is a likelihood that the image quality may deteriorate if the re-compression-coding is performed based on the encoding difficulty because a correlative relationship is small between the encoding difficulty of the input video signal and that of the output video signal. Therefore, the Patent Document 1 sets the code volume to be assigned based on the encoding difficulty to perform the re-compression-coding only when the picture type and so on are the same. As a result, there is a problem that the compression ratio cannot be sufficiently improved.

### BRIEF DESCRIPTION OF THE DRAWINGS

FIG. 1 is a schematic configuration of an image processing system according to one embodiment.

FIGS. 2A and 2B are examples of the input and output video signals.

FIG. 3 is a flowchart showing an example of the processing operation of the encoding difficulty modifier 3.

FIG. 4 is a flowchart showing the processing operation of the encoding difficulty modifier 3 in more detail.

FIG. 5 is an internal configuration of the encoding difficulty modifier 3.

FIG. 6 is a table showing a processing target of each component in the image processing device 100 in a case where the input video signal of FIG. 2A is inputted.

### DETAILED DESCRIPTION

In general, an image processing device includes an image decoder, an encoding difficulty calculator, an encoding difficulty modifier, a coding volume controller, an image encoder. The image decoder is configured to decode a compression coded input video signal and configured to calculate an image characteristic value of the decoded signal. The encoding difficulty calculator is configured to calculate a first encoding difficulty indicative of a compression-coding difficulty of the decoded signal based on the image characteristic value. The encoding difficulty modifier is configured to generate a second encoding difficulty based on the first encoding difficulty and an image characteristic information set from outside for re-compression-coding the input video signal with a predetermined coding volume. The coding volume controller is configured to set a coding volume to be assigned based on the second encoding difficulty. The image encoder is configured to generate an output video signal by re-compression-coding the decoded signal with the assigned coding volume.

Embodiments will now be explained with reference to the accompanying drawings.

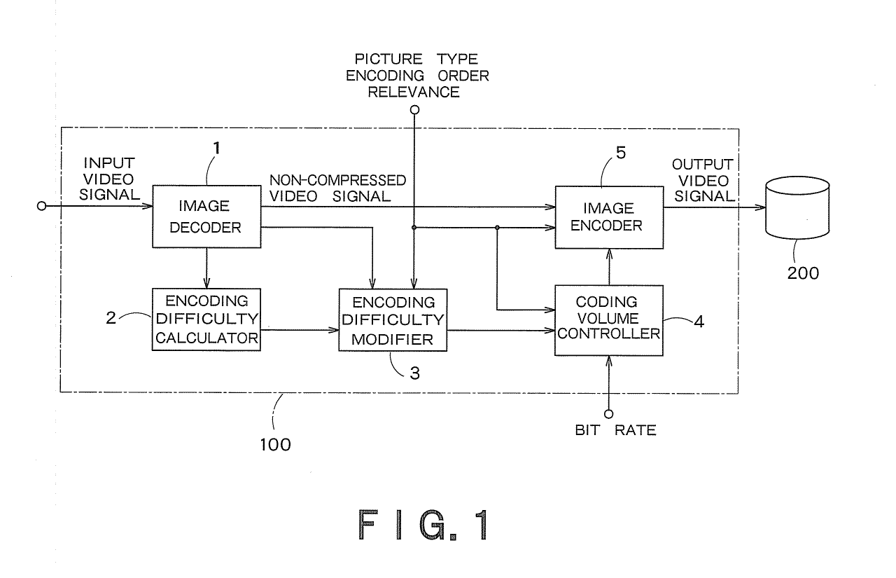

FIG. 1 is a schematic configuration of an image processing system according to one embodiment. The image processing system of FIG. 1 has an image processing device 100 and a recording media 200. The image processing device 100 has an image decoder 1, an encoding difficulty calculator 2, an encoding difficulty modifier 3, a coding volume controller 4 and an image encoder 5. The image processing device 100 is a transcoder which decodes a compression-coded input video signal and re-compression-coding the decoded video signal while modifying a compression processing, namely, at least one of a compressing scheme, a picture type, a encoding order and a relevance for compression-coding, so as to generate an compression-coded output video signal whose compression ratio is higher than that of the input video signal. Each part of the image processing device 100 can be integrated in a semiconductor chip, for example. The recording media 200 can be a hard disk or a flash memory, for example, and stores the output video signal generated by the image processing device 100.

The compression-coded input video signal is inputted to the image decoder 1. The input video signal is a compression-coded signal using an inter-frame prediction such as an MPEG-2, MPEG-4 and H.264. The input video signal has an intra picture (hereinafter, I-Picture) obtained by intra-frame coding, a predictive picture (hereinafter, P-Picture) obtained by inter-frame coding in one direction, and a bi-directional predictive picture (hereinafter, B-Picture) obtained by inter-frame coding in bi-direction.

Hereinafter, the image processing device 100 will be mainly explained. The image decoder 1 decodes the input video signal by each picture to generate a non-compressed video signal. The non-compressed video signal is a group of decoded pictures and is outputted form the image decoder 1 in display order. Furthermore, the image decoder 1 provides the encoding difficulty calculator 2 with a statistics value (image characteristic value) of a picture to be decoded (hereinafter, target picture). The statistics value is used for calculating an encoding difficulty which will be explained below. The statistics value includes a picture type “t” of the target picture, an average value “q” of a quantizing step width, and a coding volume “b” before decoding, for example.

Additionally, the image decoder 1 recites pictures referred to by the target picture (hereinafter, reference pictures) and calculates a ratio of blocks in the target picture referring to the reference picture to all the blocks in the target picture among the blocks in the target picture to provide the ratio to the encoding difficulty modifier 3.

For example, the target picture is assumed to be a P-Picture and refers to a reference picture “X”. Furthermore, a ratio Rintra of the intra-coded block among the blocks in the target picture is assumed to be “20”%. Then, the other blocks refer to the reference picture “X”. Therefore, the ratio of blocks in the target picture referring to the reference picture to all the blocks in the target picture “X” is “100−Rintra=100−20=80”%.

In another example, the target picture is assumed to be a B-Picture and refers to a reference picture “Y” followed by the target picture and a reference picture “Z” following the target picture. Furthermore, a ratio Rintra of the intra-coded blocks among the blocks in the target picture is assumed to be “20”%, a ratio Rfwd of the blocks referring to only the reference picture “Y” to be “40”%, a ratio Rbwd of the blocks referring to only the reference picture “Z” to be “10”%, a ratio Rbipred of the blocks referring to both reference pictures “Y” and “Z” to be “30”%. Then, the ratio of blocks in the target picture referring to the reference picture to all the blocks in the target picture “Y” is “Rfwd+Rbipred/2=40+30/2=55”%, and the ratio of blocks in the target picture referring to the reference picture to all the blocks in the target picture “Z” is “Rbwd+Rbipred/2=10+30/2=25”%.

The ratio calculated as explained above is used for modifying an encoding difficulty by the encoding difficulty modifier 3. The detail will be explained below.

The encoding difficulty calculator 2 calculates the encoding difficulty (first encoding difficulty) of the target picture based on the statistics value provided by the image decoder 1 to provide the encoding difficulty to the encoding difficulty modifier 3. The encoding difficulty calculator 2 calculates the encoding difficulty “C” based on the following equation (1), for example.

C=K(t)*q*b (1)

Here, the K(t) is a predetermined constant depending on the picture type “t” (t=I, P or B). When one picture is encoded with a certain quantizing step width, the coding volume of the I-Picture is the largest and that of the B-Picture is the smallest. In order to set the encoding difficulty of the same picture to be constant, it is preferable to set “K(I)<K(P)<K(B)”. When the target picture is similar to the reference picture, “q*b” becomes small, while when the target picture is not similar to the reference picture, “q*b” becomes large. That is, the statistics value is determined in consideration of the relevance between the target picture and the reference picture in the input video signal.

The encoding difficulty “C” indicates a difficulty for compression-coding the target picture decode by the image decoder 1. When the target picture is compression-coded with constant image quality, as the encoding difficulty “C” of the target picture is lower, the target picture can be compression-coded with smaller amount of the coding volume.

The above equation (1) corresponds to estimating an encoding difficulty of the input video signal inputted to the image decoder 1. As described above, the statistics value used by the equation (1) varies according to the relevance between the target picture and the reference picture, and the encoding difficulty “C” also varies according to the relevance. Therefore, the encoding difficulty calculator 2 calculates the encoding difficulty “C” based on the statistics value, thereby calculating the encoding difficulty accurately.

Note that the encoding difficulty calculator 2 can calculate the encoding difficulty “C” based on the statistics value, namely, at least one of the picture type “t” of the target picture, the average value “q” of the quantizing step width and the coding volume “b” before decoded, and can calculate the encoding difficulty “C” by a different way from the above equation (1).

An image characteristic information of an output video signal, namely, the picture type, the encoding order and the relevance is set from outside in the encoding difficulty modifier 3. The image characteristic information is set from outside of the image processing device 100 in order to re-compression-code the input video signal with a desired coding volume. Then, the encoding difficulty modifier 3 modifies the encoding difficulty calculated by the encoding difficulty calculator 2 to the encoding difficulty indicative of the difficulty for re-compression-coding the non-compressed signal based on the image characteristic information. The encoding difficulty modifier 3 provides the coding volume controller 4 with the modified encoding difficulty (second encoding difficulty).

The coding volume controller 4 sets a coding volume to be assigned to each picture based on a bit rate, the picture type, the encoding order, the relevance set from outside and, the encoding difficulty modified by the encoding difficulty modifier 3. More specifically, the coding volume controller 4 sets the coding volume to be assigned to be smaller as the modified encoding difficulty is lower. The image encoder 5 re-compression-codes the non-compressed video signal with the coding volume to be assigned to generate the output video signal so that the compression ratio becomes higher as the set coding volume to be assigned is smaller.

In the present embodiment, because the encoding difficulty modifier 3 is provided in the image processing device 100, an appropriate coding volume can be assigned even if there is a difference between at least one of the encoding order, the picture type and the relevance of the input side and those of the output side. For example, as the encoding difficulty of the output side picture is higher, the coding volume to be assigned can be set larger, thereby performing the re-compression-coding while suppressing the degradation of the image quality. Furthermore, as the encoding difficulty of the output side picture is lower, the coding volume to be assigned can be set smaller, thereby improving the compression ratio.

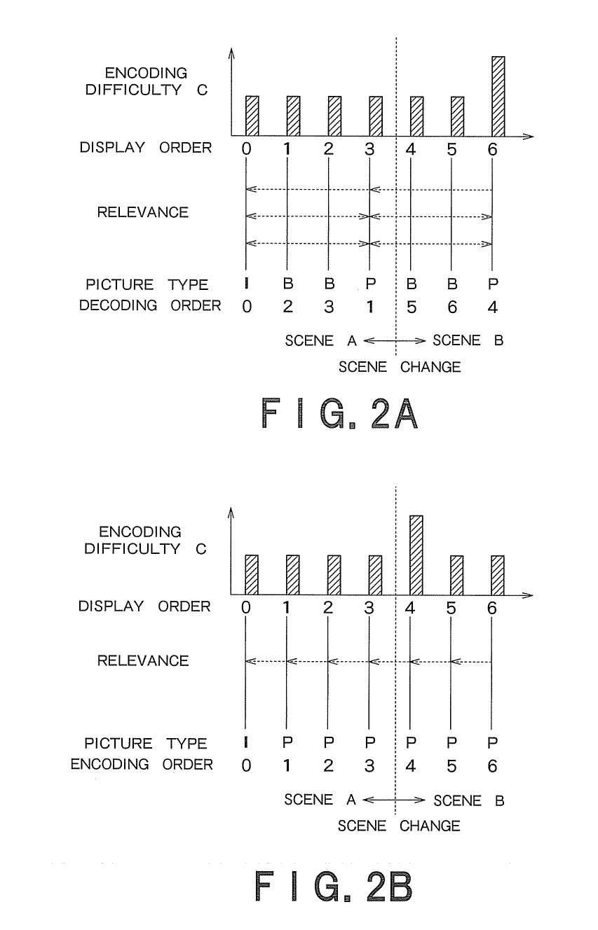

FIGS. 2A and 2B are examples of the input and output video signals. FIG. 2A shows the encoding difficulty, the display order, the relevance, the picture type and the decoding order of the input video signal, respectively. For example, FIG. 2A shows that the B-Picture having the display order of “1” refers to the picture having the display order of “0” and the picture having the display order of “3”, and that the P-Picture having the display order of “3” refers to the picture having the display order “0”. FIG. 2B shows the (modified) encoding difficulty, the display order, the relevance, the picture type and the encoding order of the output video signal, respectively. Hereinafter, the picture having the display order of “n” will be expressed as picture “n”, and the encoding difficulty of the picture “n” will be expressed as “C(n)”.

The encoding difficulty “C” of FIG. 2A is calculated by the encoding difficulty calculator 2 of FIG. 1 based on the above equation (1). Furthermore, the display order, the relevance, the picture type and the decoding order are defined in the input video signal. On the other hand, the encoding difficulty “C” of FIG. 2B is obtained by the encoding difficulty modifier 3 by modifying the encoding difficulty “C” calculated by the encoding difficulty calculator 2 of FIG. 1. The display order is defined in the input video signal, and the relevance, the picture type and the encoding order are set from outside.

For simplifying the explanation, the following is assumed in FIGS. 2A and 2B. There is a scene change from a scene “A” to a scene “B” between the picture “3” and the picture “4”. The input video signal is compression-coded in the MPEG-2 scheme, and the picture types are “I”, “B”, “B”, “P”, “B”, “B” and “P”, respectively. This compression process is used in normal digital broadcast. On the other hand, the output video signal is compression-coded in the H.264 (base line profile) scheme, and the picture types are “I”, “P”, “P”, “P”, “P”, “P”, “P” and “P”, respectively. This compression process is used for recording the video signal in a cellular phone for example. FIGS. 2A and 2B show an example where the compression ratio is improved by converting the compression scheme from the MPEG-2 to the H.264.

FIG. 2A shows an example where the encoding difficulty “C(0)” to “C(5)” are the same and the encoding difficulty “C(6)” is higher than the encoding difficulty “C(0)” to “C(5)” as a result of calculating the encoding difficulty “C” based on the above equation (1). The picture “6” is in the scene “B” and refers to only the picture “3” in another scene “A”, and therefore “q*b” in the above equation (1) becomes large. This is the reason that the encoding difficulty “C(6)” is higher. Although the picture “4” and the picture “5” refer to the picture in another scene “A” as well, the encoding difficulty “C(4)” and “C(5)” are not high because the picture “4” and the picture “5” also refer to the picture “6” the encoding process of which has been already completed and in the same scene “B”.

Then, the modification of the encoding difficulty “C” will be explained with reference to FIGS. 2A and 2B as an example.

As described above, because the picture “4” in the input video signal of FIG. 2A refers to the picture “6” in the same scene “B”, the encoding difficulty “C(4)” is not so high, while the encoding difficulty “C(6)” of the picture “6” is high.

On the other hand, because the picture “4” in the output video signal refers to only the picture “3” in another scene “A”, the image quality may be decreased unless a large amount of the coding volume is assigned. Contrarily, because the picture “6” refers to the picture “5” in the same scene “B”, the image quality is not so decreased even if not a large amount of the coding volume is assigned. If a large amount of the coding volume is assigned, the compression rate cannot be improved.

Therefore, as shown in FIG. 2B, the encoding difficulty modifier 3 modifies the encoding difficulty “C(4)” so as to enlarge it and modifies the encoding difficulty “C(6)” so as to lessen it.

More general case will be explained below. It can be considered that the reason that the encoding difficulty of the target picture (hereinafter, picture “A”) is lower than that of the reference picture (hereinafter, picture “B”) is that the picture “A” is similar to the picture “B” regardless of the presence/absence of the scene change. Then, if the encoding order of the picture “A” is prior to that of the picture “B”, the picture “A” cannot refer to the picture “B” when the picture “A” is re-compression-coded. Therefore, it is difficult to compression-code the picture “A” while suppressing the degradation of the image quality.

Accordingly, the encoding difficulty modifier 3 has to modify the encoding difficulty of the picture “A” so as to enlarge it. At this time, on the compression-coding process of the output video signal, because the picture “A” is re-compression-coded prior to the picture “B”, the picture “B” can refer to the picture “A” which is similar to the picture “B” at a time of compression-coding the picture “B”. Therefore, even if the encoding difficulty of the picture “B” is not so high, the picture “B” can be compression-coded while suppressing the degradation of the image quality on the compression processing of the output video signal. Accordingly, the encoding difficulty modifier 3 can further modify the encoding difficulty of the picture “B” so as to lessen it.

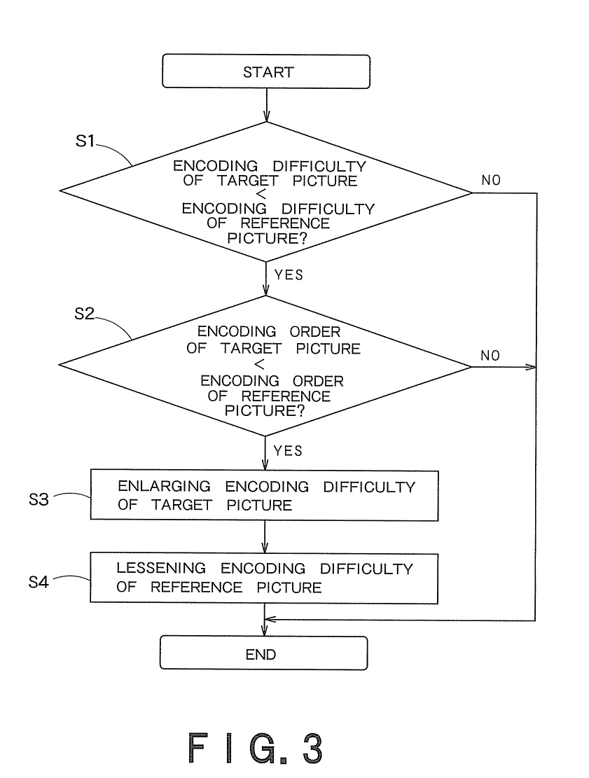

FIG. 3 is a flowchart showing an example of the processing operation of the encoding difficulty modifier 3. As described above, when the encoding difficulty of the target picture is lower than that of the reference picture (Step1-YES) and when the encoding order of the target picture is prior to that of the reference picture (Step2-YES), the encoding difficulty modifier 3 modifies the encoding difficulty of the target picture so as to enlarge it (Step S3). Furthermore, the encoding difficulty modifier 3 can modify the encoding difficulty of the reference picture so as to lessen it (Step S4). Note that when the target picture is the I-Picture which refers to no other pictures, the encoding difficulty modifier 3 does not modify the encoding difficulty and the encoding difficulty is not changed.

In this way, the encoding difficulty of each picture in the input video signal shown in FIG. 2A is calculated based on the above equation (1), and contrarily, the encoding difficulty of each picture in the output video signal shown in FIG. 2B is obtained by the encoding difficulty modifier 3 by modifying, based on the processing operation of FIG. 3, the encoding difficulty calculated by the encoding difficulty calculator 2.

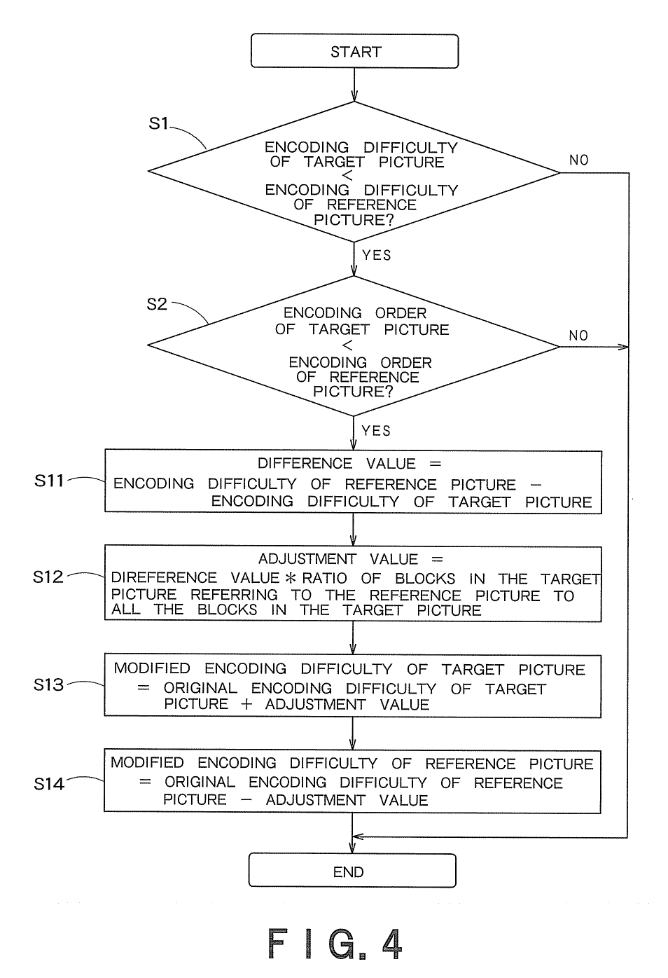

FIG. 4 is a flowchart showing the processing operation of the encoding difficulty modifier 3 in more detail and showing the processing operation of Steps S3 and S4 of FIG. 3 in more detail. When the encoding difficulty of the target picture is lower than that of the reference picture (Step1-YES) and when the encoding order of the target picture is prior to that of the reference picture (Step2-YES), the encoding difficulty modifier 3 modifies the encoding difficulty based on the following processing operation.

Firstly, the encoding difficulty modifier 3 calculates a difference value by subtracting the encoding difficulty of the target picture from that of the reference picture (Step S11). Secondly, the encoding difficulty modifier 3 calculates an adjustment value by multiplying the difference value by the ratio of blocks in the target picture referring to the reference picture to all the blocks in the target picture (Step S12). The ratio is inputted from the image decoder 1.

As the ratio of blocks in the target picture referring to the reference picture to all the blocks in the target picture is larger in the input video signal, it becomes more difficult to compression-code the target picture in the compression processing of the output video signal when the target picture cannot refer to the same reference picture. Therefore, it is preferable that the encoding difficulty modifier 3 modifies the encoding difficulty so as to enlarge it. Accordingly, the encoding difficulty modifier 3 performs the processing of Step S12 in order to set the adjustment value corresponding to the modifying amount of the encoding difficulty to be depending on the ratio.

Furthermore, the encoding difficulty modifier 3 obtains the encoding difficulty of the target picture by performing a modification for adding the adjustment value by the encoding difficulty of the target picture before modified (Step S13) and obtains the encoding difficulty of the reference picture by performing a modification for subtracting the adjustment value from the encoding difficulty of the reference picture before modified (Step S14).

As described above, as the ratio of blocks in the target picture referring to the reference picture to all the blocks in the target picture is larger, the encoding difficulty of the target picture becomes higher and that of the reference picture becomes lower.

In FIG. 4, Step S12 corresponds to an adjustment value calculator, Step S13 corresponds to a first difficulty modifier, and Step S14 corresponds to a second difficulty modifier.

Note that FIG. 4 shows an example where the encoding difficulty modifier 3 performs the modification in consideration of the picture type of the target picture, the encoding order and the relevance. However, the encoding difficulty modifier 3 can perform the modification in consideration of at least one of them

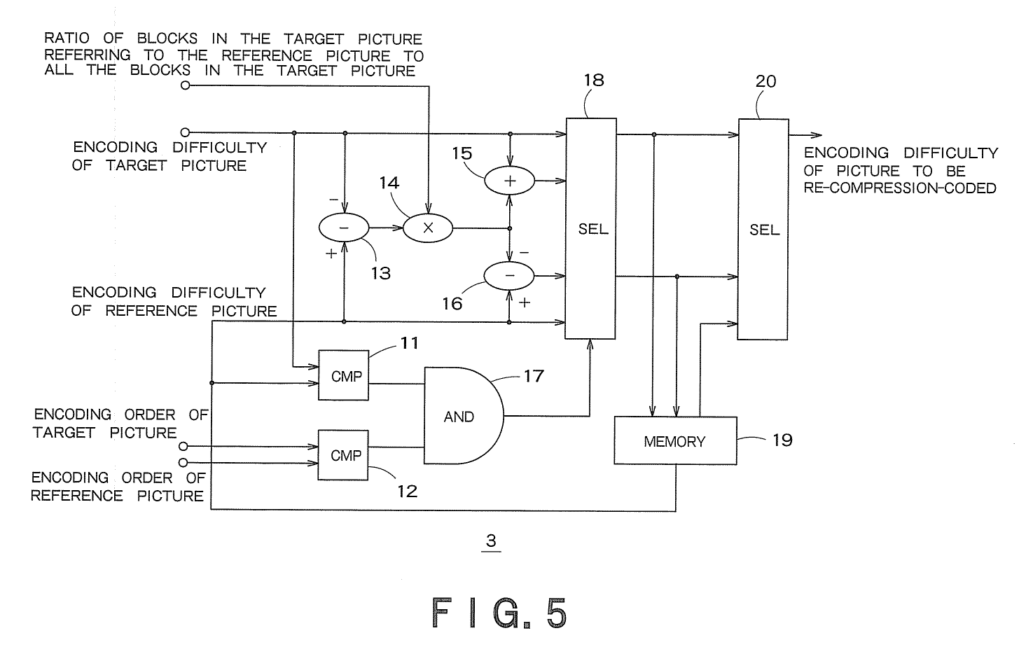

FIG. 5 is an internal configuration of the encoding difficulty modifier 3 in a case of implementing the processing operation of FIG. 4 in hardware. The encoding difficulty modifier 3 has first and second comparators (CMP) 11 and 12, first and second subtractors 13 and 16, a multiplier 14, an adder 15, an AND operator (AND) 17, first and second selectors (SEL) 18 and 20 (SEL) and a memory 19.

The first comparator 11 compares the encoding difficulty of the target picture with that of the reference picture. When the encoding difficulty of the target picture is lower than that of the reference picture, the first comparator 11 outputs high, and otherwise, the first comparator 11 outputs low (corresponding to Step S1 of FIG. 4). The second comparator 12 compares the encoding order of the target picture with that of the reference picture. When the encoding order of the target picture is prior to that of the reference picture, the second comparator 12 outputs high, and otherwise, the second comparator 12 outputs low (corresponding to Step S2). When outputs of both of the first comparator 11 and the second comparator 12 are high, the AND operator 17 outputs high, and otherwise, the AND operator outputs low.

The first subtractor 13 calculates the difference value by subtracting the encoding difficulty of the target picture from that of the reference picture (corresponding to Step S11). The multiplier 14 calculates the adjustment value by multiplying the difference value by the ratio of blocks in the target picture referring to the reference picture to all the blocks in the target picture (corresponding to Step S12). The adder 15 calculates a first modification value by adding the adjustment value by the encoding difficulty of the target picture (corresponding to Step S13). The second subtractor 16 calculates a second modification value by subtracting the adjustment value from the encoding difficulty of the reference picture (corresponding to Step S14).

When the output of the AND operator 17 is high, the first selector 18 outputs the first modification value as the modified encoding difficulty of the target picture and outputs the second modification value as the modified encoding difficulty of the reference picture. Furthermore, when the output of the AND operator 17 is low, the first selector 18 outputs the encoding difficulty of the target picture and that of the reference picture themselves as the modified encoding difficulty of the target picture and that of the reference picture, respectively,

That is, only when the outputs of both of the first comparator 11 and the second comparator 12 are high, the encoding difficulty modifier 3 performs the modification, and when at least one of the outputs is low, the encoding difficulty modifier 3 does not perform the modification.

The memory 19 stores the modified encoding difficulty. The stored encoding difficulty is, if necessary, used for modifying the encoding difficulty of the pictures which are decoded afterward and for setting the coding volume to be assigned of the pictures which are re-compression-coded afterward.

The second selector 20 selects one of the encoding difficulty stored in the memory 19 and that outputted from the first selector 18 as the encoding difficulty of the picture re-compression-coded by the image encoder 5 to output the modified encoding difficulty to provide it to the coding volume controller 4.

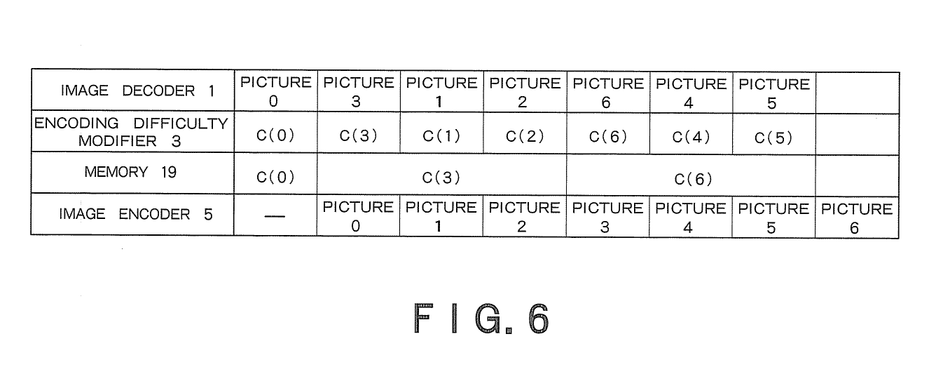

FIG. 6 is a table showing a processing target of each component in the image processing device 100 in a case where the input video signal of FIG. 2A is inputted. The column direction of FIG. 6 shows time passage, the first row shows the picture decoded by the image decoder 1 (namely, the target picture), the second row shows the encoding difficulty of the modification target performed by the encoding difficulty modifier 3, the third row shows the encoding difficulty stored in the memory 19 in the encoding difficulty modifier 3, the fourth row shows the picture re-compression-coded by the image encoder 5.

With reference to FIG. 4 to FIG. 6, the processing operation of the image processing device 100 will be specifically explained.

Firstly, when the picture “0” having the decoding order of “0” is inputted as a target picture, the image decoder 1 decodes the picture “0”, and the decoded picture “0” is stored in a memory (not shown) in the image decoder 1. Furthermore, the encoding difficulty calculator 2 calculates the encoding difficulty “C(0)” based on the above equation (1). Because the picture “0” is an I-Picture and refers to no other picture, the encoding difficulty modifier 3 does not modify the encoding difficulty “C(0)”, and the memory 19 stores the encoding difficulty “C(0)”.

Next, when the picture “3” having the decoding order of “1” is inputted as a target picture, the image decoder 1 decodes the picture “3”, and the decoded picture “3” is stored in the memory in the image decoder 1. Furthermore, the encoding difficulty calculator 2 calculates the encoding difficulty “C(3)” based on the above equation (1). Although the picture “3” refers to the picture “0”, the encoding order of the picture “3” is not prior to that of the picture “0” (Step2-NO of FIG. 4). Therefore, the encoding difficulty modifier 3 does not modify the encoding difficulty “C(3)”, and the memory 19 stores the encoding difficulty “C(3)”.

In parallel with the decoding processing of the picture “3”, the image decoder 1 provides the image encoder 5 with the decoded picture “0” having the encoding order of “0” stored in the internal memory, and the encoding difficulty modifier 3 provides the coding volume controller 4 with the encoding difficulty “C(0)” stored in the memory 19. The coding volume controller 4 sets the coding volume to be assigned of the picture “0” according to the encoding difficulty “C(0)”, and the image encoder 5 re-compression-codes the picture “0” according to the coding volume to be assigned.

Next, when the picture “1” having the decoding order of “2” is inputted as a target picture, the image decoder 1 decodes the picture “1”. The encoding order of the picture “1” is “1”, and the picture “1” is decoded by the image decoder 1 and successively encoded by the image encoder 5 as shown in FIG. 6. Therefore, the image decoder 1 provides the image encoder 5 with the decoded picture “1” without being stored in the internal memory. Furthermore, the encoding difficulty calculator 2 calculates the encoding difficulty “C(1)” based on the above equation (1). Although the picture “1” refers to the picture “0” and the picture “3”, the encoding order of the picture “1” is not prior to that of the picture “0” (Step2-NO of FIG. 4). Therefore, the encoding difficulty “C(1)” is not modified in relation to the picture “0”. Furthermore, as shown in FIG. 2A, the encoding difficulty “C(1)” is equal to the encoding difficulty “C(3)” stored in the memory 19 (Step S1-NO of FIG. 3). Therefore, the encoding difficulty “C(1)” is not modified in relation to the picture “3”. As a result, the encoding difficulty modifier 3 does not modify the encoding difficulty “C(3)”.

Here, as described above, because the encoding order of the picture “1” is “1”, the encoding difficulty modifier 3 provides the coding volume controller 4 with the encoding difficulty “C(1)” without being stored in the memory 19. The coding volume controller 4 sets the coding volume to be assigned according to the encoding difficulty “C(1)” and, the image encoder 5 re-compression-codes the picture “1” according to the coding volume to be assigned.

Then, the picture “2” having the decoding order of “3” is inputted as a target picture. At this time, similar to a case where the picture “1” is inputted as a target picture, the encoding difficulty modifier 3 provides the coding volume controller 4 with the encoding difficulty “C(2)” without modifying it, and the image encoder 5 re-compression codes the picture “2” having the encoding order of “2” according to the coding volume to be assigned set by the coding volume controller 4.

Next, when the picture “6” having the decoding order of “4” is inputted as a target picture, the image decoder 1 decodes the picture “6”, and the decoded picture “6” is stored in the memory in the image decoder 1. Furthermore, the encoding difficulty calculator 2 calculates the encoding difficulty “C(6)” based on the above equation (1). Here, although picture “6” refers to the picture “3”, the picture “6” and the picture “3” are in different scenes, respectively. Therefore, the picture “6” is not similar to the picture “3”. Accordingly, “q*b” in the above equation (1) becomes large, and the encoding difficulty “C(6)” becomes high. The picture “6” refers to the picture “3”. However, the encoding difficulty “C(6)” is higher than the encoding difficulty “C(3)” (Step S1-NO of FIG. 4). Therefore, the encoding difficulty modifier 3 does not modify the encoding difficulty “C(6)”. Because the encoding order of the picture “6” is “6”, the memory 19 stores the encoding difficulty “C(6)”.

In parallel with the decoding processing of the picture “6”, the image decoder 1 provides the image encoder 5 with the decoded picture “3” having the encoding order of “3” stored in the internal memory, and the encoding difficulty modifier 3 provides the coding volume controller 4 with the encoding difficulty “C(3)” stored in the memory 19. The coding volume controller 4 sets the coding volume to be assigned of the picture “3” according to the encoding difficulty “C(3)”, and the image encoder 5 re-compression-codes the picture “3” according to the coding volume to be assigned.

Next, when the picture “4” having the decoding order of “5” is inputted as a target picture, the image decoder 1 decodes the picture “4”. The encoding order of the picture “4” is “4”, and the picture “4” is decoded by the image decoder 1 and successively encoded by the image encoder 5 as shown in FIG. 6. Therefore, the image decoder 1 provides the image encoder 5 with the decoded picture “4” without being stored in the internal memory. Furthermore, the encoding difficulty calculator 2 calculates the encoding difficulty “C(4)” based on the above equation (1). The picture “4” refers to the picture “3” and the picture “6”. However, the encoding order of the picture “4” is not prior to that of the picture “3” (Step2-NO of FIG. 4). Therefore, the encoding difficulty “C(4)” is not modified in relation to the picture “3”. On the other hand, the encoding difficulty “C(4)” is lower than the encoding difficulty “C(6)” (Step S1-YES), and the encoding order of the picture “4” is prior to that of the picture “6” (Step S2-YES). Therefore, the encoding difficulty modifier 3 calculates the difference value “C(6)-C(4)” (Step S11) and multiplies the difference value by the ratio of the block of the picture “4” which refers to the picture “6” to calculate the adjustment value (Step S12). Furthermore, the encoding difficulty modifier 3 performs the modification by adding the adjustment value by the encoding difficulty “C(4)” so as to enlarge the encoding difficulty “C(4)” (Step S13), and by subtracting the adjustment value from the encoding difficulty “C(6)” so as to lessen the encoding difficulty “C(6)” (Step S14). The memory 19 of FIG. 5 stores the modified encoding difficulty “C(6)”.

Here, because the encoding order of the picture “4” is “4”, the encoding difficulty modifier 3 provides the coding volume controller 4 with the modified encoding difficulty “C(4)” without being stored in the memory 19. The coding volume controller 4 sets the coding volume to be assigned according to the encoding difficulty “C(4)”, and the image encoder 5 re-compression-codes the picture “4” according to the coding volume to be assigned.

Because the picture “4” is re-compression-coded by referring to only the picture “3” in another scene “A”, if the picture “4” is re-compression-coded without modifying the encoding difficulty “C(4)” to be enlarged, the image quality may decrease. Contrarily, in the present embodiment, because the encoding difficulty “C(4)” is modified to be enlarged, the coding volume controller 4 can set the coding volume to be assigned to be large. As a result, the picture “4” can be re-compression-coded while suppressing the degradation of the image quality.

Next, when the picture “5” having the decoding order of “6” is inputted as a target picture, the image decoder 1 decodes the picture “5”. The encoding order of the picture “5” is “5”, and the picture “5” is decoded by the image decoder 1 and successively encoded by the image encoder 5 as shown in FIG. 6. Therefore, the image decoder 1 provides the image encoder 5 with the decoded picture “5” without being stored in the internal memory. Furthermore, the encoding difficulty calculator 2 calculates the encoding difficulty “C(5)” based on the above equation (1). The picture “5” refers to the picture “3” and the picture “6”. The encoding order of the picture “5” is prior to that of the picture “3” (Step2-NO of FIG. 4). Therefore, the encoding difficulty “C(5)” is not modified in relation to the picture “3”. On the other hand, when the encoding difficulty “C(5)” is lower than the modified encoding difficulty “C(6)” stored in the memory 19 (Step S1-YES), because the encoding order of the picture “5” is prior to that of the picture “6” (Step S2-YES), the encoding difficulty modifier 3 performs the modification to enlarge the encoding difficulty “C(5)” (Step S13) and lessen the encoding difficulty “C(6)” stored in the memory 19 (Step S14). However, when the encoding difficulty “C(5)” is not lower than the encoding difficulty “C(6)” stored in the memory 19 (Step S1-NO), the encoding difficulty modifier 3 does not modify the encoding difficulty “C(5)” and the encoding difficulty “C(6)” stored in the memory 19.

Here, as described above, the encoding order of the picture “5” is “5”, the encoding difficulty modifier 3 provides the coding volume controller 4 with the encoding difficulty “C(5)” without being stored in the memory 19. The coding volume controller 4 sets the coding volume to be assigned according to the encoding difficulty “C(5)”, and the image encoder 5 re-compression-codes the picture “5” according to the coding volume to be assigned.

After that, the image decoder 1 provides the image encoder 5 with the decoded picture “6” having the encoding order of “6” stored in the memory, and the encoding difficulty modifier 3 provides the coding volume controller 4 with the encoding difficulty “C(6)”. The coding volume controller 4 sets the coding volume to be assigned of the picture “6” according to the encoding difficulty “C(6)”, and the image encoder 5 re-compression-codes the picture “6” according to the coding volume to be assigned.

In the input video signal, because the picture “6” refers to the picture “3” in another scene “A”, the encoding difficulty “C(6)” before modified is high. However, in the output video signal, because the picture “6” refers to the picture “5” in the same scene “B”, the picture “6” can be re-compression-coded while suppressing the degradation of the image quality even if the coding volume to be assigned is not so large. If the picture “6” is re-compression-coded without modifying the encoding difficulty “C(6)” to be lessened, the coding volume to be assigned becomes large and the compression ratio cannot be improved. Contrarily, in the present embodiment, because the encoding difficulty “C(6)” is modified to be lessened, the coding volume to be assigned set by the coding volume controller 4 becomes relatively small. As a result, the picture “6” can be re-compression-coded with improved compression ratio.

Note that although not shown in FIG. 6, in parallel to re-compression-coding the picture “6” by the image encoder 5, the image decoder 1 decodes the picture inputted next to the picture “6”.

By such a manner, the input video signal having the picture “0” to the picture “6” can be re-compression-coded with high compression ratio and while suppressing the degradation of the image quality to generate the output video signal in real-time.

When it is assumed that the input video signal compression-coded in the compression process shown in FIG. 2A and that the image processing device 100 performs the re-compression-coding in the compression process shown in FIG. 2B, it is enough for the memory 19 to have a memory size for storing one encoding difficulty as shown in FIG. 6. Furthermore, when the input video signal compression-coded in a compression process different form FIG. 2A is inputted to the image processing device 100, and when the image processing device 100 generates the output video signal in different compression process, the memory 19 can be provided which can store the encoding difficulty according to the possible input and output video signals. For example, in the H.264 scheme, because the maximum number of the reference pictures is “16” whose decoding order is prior to an arbitral picture and the display order is not prior to the arbitral picture, when the input video signal compression-coded in the H.264 scheme is inputted, it is enough for the memory 19 to store the “16” encoding difficulty.

As described above, in the present embodiment, the encoding difficulty modifier 3 is provided in the image processing device 100 and modifies the first encoding difficulty for compression-coding the signal obtained by decoding the input video signal to generate the second encoding difficulty. Because the encoding difficulty modifier 3 generates the second encoding difficulty based on the image characteristic information of the output video signal, even if the compression processing of the input video signal differs from that of the output video signal, the re-compression-coding can be performed with the high compression ratio and while suppressing the degradation of the image quality in real-time.

Note that the input video signal can be a signal compression-coded using the intra-frame prediction, and is not limited to the MPEG-2 and H.264 scheme and so on. Furthermore, it is not always necessarily to target setting the compression ratio of the output video signal higher than that of the input video signal. The present embodiment can be applicable for generating the output video signal of which one of the compression scheme, the picture type, the encoding order and the relevance of the picture for compression-coding is only converted. Also in this case, the output video signal can be generated while suppressing the degradation of the image quality.

At least a part of the image processing device explained in the above embodiments can be formed of hardware or software. When the image processing device is partially formed of the software, it is possible to store a program implementing at least a partial function of the image processing device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the image processing device can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and sprit of the invention.

1. An image processing device comprising:
an image decoder configured to decode a compression coded input video signal and configured to calculate an image characteristic value of the decoded signal;
an encoding difficulty calculator configured to calculate a first encoding difficulty indicative of a compression-coding difficulty of the decoded signal based on the image characteristic value;
an encoding difficulty modifier configured to generate a second encoding difficulty based on the first encoding difficulty and an image characteristic information set from outside for re-compression-coding the input video signal with a predetermined coding volume;
a coding volume controller configured to set a coding volume to be assigned based on the second encoding difficulty; and
an image encoder configured to generate an output video signal by re-compression-coding the decoded signal with the assigned coding volume.

2. The device of claim 1, wherein the image decoder is configured to calculate the image characteristic value based on a relevance between a target picture to be a target to calculate the first encoding difficulty and a reference picture referred to by the target picture, and
the encoding difficulty modifier is configured to generate the second encoding difficulty higher than the first encoding difficulty when the first encoding difficulty is lower than the encoding difficulty of the reference picture and an encoding order of the target picture is prior to an encoding order of the reference picture.

3. The device of claim 2, wherein the encoding difficulty modifier is configured to modify the encoding difficulty of the reference picture to be lessened when the first encoding difficulty is lower than the encoding difficulty of the reference picture and the encoding order of the target picture is prior to the encoding order of the reference picture.

4. The device of claim 1, wherein the image decoder is configured to calculate a ratio of a block in the target picture referring to the reference picture to all the blocks in the target picture, and
the encoding difficulty modifier is configured to modify the second encoding difficulty at a larger volume as the ratio is higher.

5. The device of claim 2, wherein the encoding difficulty modifier comprises:
an adjustment value calculator configured to calculate an adjustment value by multiplying a ratio of a block in the target picture referring to the reference picture to all the blocks in the target picture by a difference value obtained by subtracting an encoding difficulty of the target picture from the encoding difficulty of the reference picture;
a first difficulty modifier configured to obtain the second encoding difficulty by adding the first encoding difficulty to the adjustment value; and
a second difficulty modifier configured to obtain a modified encoding difficulty of the reference picture by subtracting the adjustment value from the encoding difficulty of the reference picture;
wherein each of the adjustment value calculator, the first difficulty modifier and the second difficulty modifier is configured to perform a processing only when the first encoding difficulty is lower than the encoding difficulty of the reference picture and the encoding order of the target picture is prior to the encoding order of the reference picture.

6. The device of claim 2, wherein the encoding difficulty modifier comprises:
a first comparator configured to determine whether the first encoding difficulty is lower than the encoding difficulty of the reference picture;
a second comparator configured to determine whether the encoding order of the target picture is prior to the encoding order of the reference picture;
a first subtractor configured to calculate a difference value by subtracting the encoding difficulty of the target picture from the encoding difficulty of the reference picture;
a multiplier configured to calculate an adjustment value by multiplying a ratio of a block in the target picture referring to the reference picture to all the blocks in the target picture by the difference value;
an adder configured to calculate a first modified value by adding the adjustment value to the first encoding difficulty;
a second subtractor configured to calculate a second modified value by subtracting the adjustment value from the encoding difficulty of the reference picture; and
a selector configured to switch whether the first modified value is selected as the second encoding difficulty and the second modified value is selected as a modified encoding difficulty of the reference picture, or the first encoding difficulty is selected as the second difficulty and the encoding difficulty of the reference picture is selected as the modified encoding difficulty of the reference picture, according to results determined by the first and the second comparators.

7. The device of claim 2, wherein the image decoder is configured to calculate the image characteristic value based on at least one of a picture type of the target picture, an average value of a quantizing step width and an coding volume of the input video signal to be decoded, and
the image characteristic information includes at least one of the picture type of the target picture, the encoding order and the relevance between the target picture and the reference picture.

8. The device of claim 7, wherein the encoding difficulty calculator is configured to set a product of a constant defined according to the picture type of the target picture, the average value of the quantizing step width and the coding volume of the input video signal to be decoded, as the first encoding difficulty.

9. An image processing system comprising:
an image decoder configured to decode a compression coded input video signal and configured to calculate an image characteristic value of the decoded signal;
an encoding difficulty calculator configured to calculate a first encoding difficulty indicative of a compression-coding difficulty of the decoded signal based on the image characteristic value;
an encoding difficulty modifier configured to generate a second encoding difficulty based on the first encoding difficulty and an image characteristic information set from outside for re-compression-coding the input video signal with a predetermined coding volume;
a coding volume controller configured to set a coding volume to be assigned based on the second encoding difficulty;
an image encoder configured to generate an output video signal by re-compression-coding the decoded signal with the assigned coding volume; and
a recording media configured to record the output video signal.

10. The system of claim 9, wherein the image decoder is configured to calculate the image characteristic value based on a relevance between a target picture to be a target to calculate the first encoding difficulty and a reference picture referred to by the target picture, and
the encoding difficulty modifier is configured to generate the second encoding difficulty higher than the first encoding difficulty when the first encoding difficulty is lower than the encoding difficulty of the reference picture and an encoding order of the target picture is prior to an encoding order of the reference picture.

11. The system of claim 10, wherein the encoding difficulty modifier is configured to modify the encoding difficulty of the reference picture to be lessened when the first encoding difficulty is lower than the encoding difficulty of the reference picture and the encoding order of the target picture is prior to the encoding order of the reference picture.

12. The system of claim 10, wherein the image decoder is configured to calculate a ratio of a block in the target picture referring to the reference picture to all the blocks in the target picture, and
the encoding difficulty modifier is configured to modify the second encoding difficulty at a larger volume as the ratio is higher.

13. The system of claim 10, wherein the encoding difficulty modifier comprises:
an adjustment value calculator configured to calculate an adjustment value by multiplying a ratio of a block in the target picture referring to the reference picture to all the blocks in the target picture by a difference value obtained by subtracting an encoding difficulty of the target picture from the encoding difficulty of the reference picture;
a first difficulty modifier configured to obtain the second encoding difficulty by adding the first encoding difficulty to the adjustment value; and
a second difficulty modifier configured to obtain a modified encoding difficulty of the reference picture by subtracting the adjustment value from the encoding difficulty of the reference picture;
wherein each of the adjustment value calculator, the first difficulty modifier and the second difficulty modifier is configured to perform a processing only when the first encoding difficulty is lower than the encoding difficulty of the reference picture and the encoding order of the target picture is prior to the encoding order of the reference picture.

14. The system of claim 10, wherein the encoding difficulty modifier comprises:
a first comparator configured to determine whether the first encoding difficulty is lower than the encoding difficulty of the reference picture;
a second comparator configured to determine whether the encoding order of the target picture is prior to the encoding order of the reference picture;
a first subtractor configured to calculate a difference value by subtracting the encoding difficulty of the target picture from the encoding difficulty of the reference picture;
a multiplier configured to calculate an adjustment value by multiplying a ratio of a block in the target picture referring to the reference picture to all the blocks in the target picture by the difference value;
an adder configured to calculate a first modified value by adding the adjustment value to the first encoding difficulty;
a second subtractor configured to calculate a second modified value by subtracting the adjustment value from the encoding difficulty of the reference picture; and
a selector configured to switch whether the first modified value is selected as the second encoding difficulty and the second modified value is selected as a modified encoding difficulty of the reference picture, or the first encoding difficulty is selected as the second difficulty and the encoding difficulty of the reference picture is selected as the modified encoding difficulty of the reference picture, according to results determined by the first and the second comparators.

15. The system of claim 10, wherein the image decoder is configured to calculate the image characteristic value based on at least one of a picture type of the target picture, an average value of a quantizing step width and an coding volume of the input video signal to be decoded, and
the image characteristic information includes at least one of the picture type of the target picture, the encoding order and the relevance between the target picture and the reference picture.

16. The system of claim 15, wherein the encoding difficulty calculator is configured to set a product of a constant defined according to the picture type of the target picture, the average value of the quantizing step width and the coding volume of the input video signal to be decoded, as the first encoding difficulty.

17. An image processing method comprising:
decoding a compression coded input video signal;
calculating an image characteristic value of the decoded signal;
calculating a first encoding difficulty indicative of a compression-coding difficulty of the decoded signal based on the image characteristic value;
generating a second encoding difficulty based on the first encoding difficulty and an image characteristic information set from outside for re-compression-coding the input video signal with a predetermined coding volume;
setting a coding volume to be assigned based on the second encoding difficulty; and
generating an output video signal by re-compression-coding the decoded signal with the assigned coding volume.

18. The method of claim 17, wherein upon calculating the image characteristic value, the image characteristic value is calculated based on a relevance between a target picture to be a target to calculate the first encoding difficulty and a reference picture referred to by the target picture, and
upon generating the second encoding difficulty, the second encoding difficulty higher than the first encoding difficulty is generated when the first encoding difficulty is lower than the encoding difficulty of the reference picture and an encoding order of the target picture is prior to an encoding order of the reference picture.

19. The method of claim 18, wherein upon generating the second encoding difficulty, the encoding difficulty of the reference picture is modified to be lessened when the first encoding difficulty is lower than the encoding difficulty of the reference picture and the encoding order of the target picture is prior to the encoding order of the reference picture.

20. The method of claim 17, wherein upon decoding the input video signal, a ratio of a block in the target picture referring to the reference picture to all the blocks in the target picture is calculated, and
upon generating the second encoding difficulty, the second encoding difficulty is modified at a larger volume as the ratio is higher.
